(19) United States
(12) Patent Application Publication
(10) Pub. No.: US 2006/0052531 A1
(43) Pub. Date: Mar. 9, 2006

(54) Modified polymer particle, packing material and column for chromatography

(75) Inventors: Takashi Kotsuka, Kanagawa (JP); Kuniaki Shimbo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K.., Minato-Ku , Tokyo 105-8518 (JP)

(21) Appl. No.: 10/527,096

(22) PCT Filed: Sep. 11, 2003
(86) PCT No.: PCT/JP03/11635

§ 371 Date: Mar. 9, 2005

Related U.S. Application Data
(60) Provisional application No. 60/411,110, filed on Sep. 17, 2002.

(51) Int. Cl. C08G 63/91

(52) U.S. Cl. 525/56

(57) ABSTRACT

An object of the present invention is to prevent an isolation of carboxyl group caused by hydrolysis of ester bond, which occurs when a polymer particle containing an ester bond is used in the presence of a strongly acidic or strongly alkaline solution to thereby improve the acid Ealkali durability of the polymer particle. When a polymer particle containing an ester bond is treated with an acid or alkali hydrous solution and thereby an ester bond which is located and exposed on the surface of the particle and is readily hydrolyzed is previously hydrolyzed to isolate a carboxyl group and then the free carboxyl group is capped by amidation, to thereby dissolve the above problem.

### TECHNICAL FIELD

The present invention relates to a polymer particle improved in the acid.alkali durability, a modified packing material for chromatography, production and modification methods thereof and a chromatography column using the packing material.

### BACKGROUND ART

Conventionally, acrylate-base and methacrylate-base polymer particles have been used as an ion exchange resin or a packing material for chromatography of various types. However, these polymer particles contain an ester bond in the molecule and use of such a polymer in an acid or alkali solution encounters decrease in the strength due to hydrolysis of the ester bond or use as a packing material for chromatography suffers from change of the analysis pattern or the like due to the isolated carboxyl group Therefore, the pH range of a solution which can be used is limited.

Use examples of the packing material for chromatography include chromatography for anion analysis. The anion chromatography includes a suppressor method (a method of using a suppressor) and a non-suppressor method (a method of not using a suppressor). As the eluent, an alkali solution at a pH of 10 or more, such as carbonate buffer or sodium hydroxide, is used in the suppressor method, whereas a weakly acidic solution such as p-hydroxybenzoic acid, phthalic acid and trimesic acid is used in the non-suppressor method. Therefore, the acrylate-base and methacrylate-base packing materials are conventionally limited only to use as a packing material for non-suppressor method (see, JP-A-2000-221179 (the term “JP-A” as used herein means an “unexamined published Japanese patent application”).

Also, a production method of anion exchanger, an anion exchanger and a measuring method of anion using the exchanger, characterized in that an acrylate- or methacrylate-base ester bond-containing anion exchanger is treated with an alkali solution to decompose the ester bond and thereby produce a hydroxyl group and/or a carboxyl group, are known (see, JP-A-2002-194117). However, in this case, the treatment of the ester bond-containing polymer with an acid or alkali hydrous solution is performed for the purpose of isolating a hydroxyl group and/or a carboxyl group and adjusting the anion retention time at the analysis by using the isolated group.

Other use examples of the packing material for chromatography include reverse phase chromatography. As the packing material for reverse phase column, a silica-base particle such as octadecylated silica gel is predominantly used. However, this packing material has a problem in the chemical stability and therefore, a polymer particle is also used. Examples of the acrylate-base or methacrylate-base packing material include an ethylene glycol dimethacrylate/alkyl methacrylate copolymer and a glycerin dimethacrylate homopolymer having introduced thereinto an octadecanoyl group.

In the silica-base particle, an unreacted silanol group remains in many cases and therefore, a separation performance sufficiently high as the reverse phase column may not be obtained. The degree in the residual amount of the silanol group can be examined by injecting an organic base such as pyridine in the packed column and comparing its peak shape. It is generally known that as the number of residual silanol groups is larger, the peak is more tailed.

In order to solve the above-described problems encountered in use of a silica-base packing material, a method of capping the remaining silanol group with an inactive group is known. Recently, in order to perform the capping at a higher density, for example, a method of reacting two terminal addition agents each capable of partially forming a complex compound in a closed container in an inert gas atmosphere (JP-A-10-72579) and a method of reacting the packing material with a chemical modifier in a supercritical fluid (JP-A-9-49829) have been reported.

On the other hand, the polymer particle-packed column is advantageous in that the chemical stability is excellent as compared with the silica column, however, this column is inferior to the silica column in that, for example, (1) the lot difference of retention volume is large, (2) the reproducibility of retention volume is bad, (3) the tailing is intensified, (4) the theoretical plate number is small. Therefore, the polymer-base distribution-adsorption column is very small in the number of products available on the market and is extremely limited in the opportunity where this column is used. Those problems seriously appear particularly when an eluent completely free of a salt is used. Such problems of the polymer particle can be solved by a method of capping the free carboxyl group of a polymer-base packing material by an inactive group (see, JP-A-2000-310623). However, also in this case, the acid.alkali durability is not sufficiently high and the pH range of the eluent used is limited.

JP-A-2003-176363 describes a packing material obtained by covering a polymer particle with a crosslinkable epoxy compound and introducing a carbon chain through an ether bond, and this packing material is revealed to have high acid.alkali durability. However, even in this case, when an acrylate-base or methacrylate-base particle is used as the base material gel and a strongly acidic or strongly alkaline solution is used as the eluent, an ester bond exposed to the particle surface is hydrolyzed to produce a new free carboxyl group and therefore, the eluent pH range usable at the analysis is limited.

### DISCLOSURE OF THE INVENTION

One object of the present invention is to provide a polymer particle improved in the acid.alkali durability, which is used in performing a liquid chromatography analysis by using a polymer particle containing an ester bond and which can be used even in a strongly acidic or strongly alkaline solution. More specifically, one object of the present invention is to provide a polymer particle improved in the acid.alkali durability, a modified packing material for chromatography, production methods thereof and a chromatography column using the packing material.

The present inventors have found that when a polymer particle containing an ester bond is treated with an acid or alkali hydrous solution and thereby an ester bond which readily comes into contact with liquid and is readily hydrolyzed is previously hydrolyzed to isolate a carboxyl group and then the free carboxyl group is capped by amidation, the acid.alkali durability of the polymer particle is enhanced. The present invention has been accomplished based on this finding.

That is, the present invention relates, for example, to the following matters.

[1] A modified polymer particle improved in the acid.alkali durability, obtained by treating a polymer particle containing an ester bond with an acid or alkali hydrous solution to partially hydrolyze the ester bond and isolate a carboxyl group and capping the free carboxyl group through amidation.

[2] The modified polymer particle improved in the acid.alkali durability as described in [1], wherein the ester bond having been hydrolyzed is an ester bond readily coming into contact with liquid.

[3] The modified polymer particle improved in the acid-alkali durability as described in [1], wherein the amine used for the amidation is an amine represented by formula (1):
NHR¹R² (1)
(wherein R¹ and R² each independently represents a hydrogen atom, an alkyl group having a carbon number of 18 or less, which may be branched or may be substituted by a halogen, or a phenyl group).

[4] The modified polymer particle improved in the acid.alkali durability as described in [3], wherein the amine used for the amidation is an amine represented by formula (2):
NH₂R³ (2)
(wherein R³ represents a hydrogen atom, an alkyl group having a carbon number of 18 or less, which may be branched or may be substituted by a halogen, or a phenyl group).

[5] A modified polymer particle improved in the acid.alkali durability, wherein when the polymer particle is packed in a column having an inner diameter of 4.6 mm and a length of 150 mm and the alkali durability is evaluated using the column by the following method, the increase percentage of the pyridine retentivity after passing an alkali eluent is 50% or less:

Evaluation Method:

(1) an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min,

(2) an alkali eluent of acetonitrile/aqueous 0.01 mol sodium hydroxide solution=50/50 is passed through the same column at a flow rate of 0.5 ml/min for 4 hours at a column temperature of 40° C., then an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min, and

(3) the pyridine retentivity of (2) is compared with the pyridine retentivity of (1).

[6] The modified polymer particle improved in the acid.alkali durability as described in any one of [1] to [5], wherein the average particle size of the polymer particle is from 1 to 50 μm.

[7] A polymer-base packing material for chromatography, using a modified polymer particle improved in the acid.alkali durability, the polymer particle being obtained by treating a polymer particle containing an ester bond with an acid or alkali hydrous solution to partially hydrolyze the ester bond and isolate a carboxyl group and then capping the free carboxyl group through amidation.

[8] The polymer-base packing material for chromatography as described in [7], wherein the ester bond having been hydrolyzed is an ester bond readily coming into contact with liquid.

[9] The polymer-base packing material for chromatography as described in [7], wherein the amine used for the amidation is an amine represented by formula (1):
NHR¹R² (1)
(wherein R¹ and R² each independently represents a hydrogen atom, an alkyl group having a carbon number of 18 or less, which may be branched or may be substituted by a halogen, or a phenyl group).

[10] The polymer-base packing material for chromatography as described in [9], wherein the amine used for the amidation is an amine represented by formula (2):
NH₂R³ (2)
(wherein R³ represents a hydrogen atom, an alkyl group having a carbon number of 18 or less, which may be branched or may be substituted by a halogen, or a phenyl group).

[11] A polymer-base packing material for chromatography, using a modified polymer particle improved in the acid.alkali durability such that when the polymer particle is packed in a column having an inner diameter of 4.6 mm and a length of 150 mm and the alkali durability is evaluated using the column by the following method, the increase percentage of the pyridine retentivity after passing an alkali eluent is 50% or less:

Evaluation Method:

(1) an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min,

(2) an alkali eluent of acetonitrile/aqueous 0.01 mol sodium hydroxide solution=50/50 is passed through the same column at a flow rate of 0.5 ml/min for 4 hours at a column temperature of 40° C., then an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min, and

(3) the pyridine retentivity of (2) is compared with the pyridine retentivity of (1).

[12] The polymer-base packing material for chromatography as described in any one of [7] to [11], wherein the average particle size of the polymer particle is from 1 to 50 μm.

[13] A method for producing a modified polymer particle improved in the acid.alkali durability, comprising treating a polymer particle containing an ester bond with an acid or alkali hydrous solution to partially hydrolyze the ester bond and isolate a carboxyl group and then capping the free carboxyl group through amidation.

[14] The method for producing a modified polymer particle improved in the acid.alkali durability as described in [13], wherein the ester bond having been hydrolyzed is an ester bond readily coming into contact with liquid.

[15] The method for producing a modified polymer particle improved in the acid.alkali durability as described in [13], wherein the amine used for the amidation is an amine represented by formula (1):
NHR¹R² (1)
(wherein R¹ and R² each independently represents a hydrogen atom, an alkyl group having a carbon number of 18 or less, which may be branched or may be substituted by a halogen, or a phenyl group).

[16] The method for producing a modified polymer particle improved in the acid.alkali durability as described in [15], wherein the amine used for the amidation is an amine represented by formula (2):
NH₂R³ (2)
(wherein R³ represents a hydrogen atom, an alkyl group having a carbon number of 18 or less, which may be branched or may be substituted by a halogen, or a phenyl group).

[17] The method for producing a modified polymer particle improved in the acid.alkali durability as described in any one of [13] to [16], wherein when the polymer particle is packed in a column having an inner diameter of 4.6 mm and a length of 150 mm and the alkali durability is evaluated using the column by the following method, the increase percentage of the pyridine retentivity after passing an alkali eluent is 50% or less:

Evaluation Method:

(1) an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min,

(2) an alkali eluent of acetonitrile/aqueous 0.01 mol sodium hydroxide solution=50/50 is passed through the same column at a flow rate of 0.5 ml/min for 4 hours at a column temperature of 40° C., then an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min, and

(3) the pyridine retentivity of (2) is compared with the pyridine retentivity of (1).

[18] The method for producing a modified polymer particle improved in the acid.alkali durability as described in any one of [13] to [16], wherein the average particle size of the polymer particle is from 1 to 50 μm.

[19] A method for producing a polymer-base packing material for chromatography, comprising producing the polymer-base packing material for chromatography described in any one of [6] to [12] by performing one or both of the hydrolysis treatment with an acid or alkali hydrous solution and the capping treatment through amidation, in the state of the polymer-base packing material being packed in the column.

[20] A chromatography column using the polymer-base packing material for chromatography improved in the acid.alkali durability described in any one of [6] to [12].

### MODE FOR CARRYING OUT THE INVENTION

In the present invention, on performing liquid chromatography using a polymer particle containing an ester bond, an ester bond which readily comes into contact with liquid and is readily hydrolyzed is previously hydrolyzed to isolate a carboxyl group and the carboxyl group is capped through amidation, whereby the ester hydrolysis occurring during use in the chromatography analysis is prevented, the acid.alkali durability of the polymer particle is improved, and a stable analysis can be performed.

More specifically, in JP-A-2000-310623, a carboxyl group generated at the polymerization step for production of a polymer particle is capped, whereas in the present invention, a readily hydrolyzable ester bond is positively hydrolyzed and thereby the acid.alkali durability is remarkably improved.

The objective polymer particle to be modified by the method of the present invention is a polymer particle containing an ester bond in the molecule and examples thereof include a crosslinkable polymer containing a polyester structure. Furthermore, even in the case of a polymer particle where the ester bond as a problem is contained in a part of the structure, when the ester bond is considered to cause reduction of the acid.alkali durability, this is an objective polymer particle to be modified by the method of the present invention.

Examples of the polymer particle containing a polyester structure include an ethylene glycol di(meth)acrylate/alkyl (meth)acrylate copolymer, an ethylene glycol di(meth)acrylate homopolymer, a glycerin di(meth)acrylate/alkyl (meth)acrylate copolymer, a glycerin di(meth)acrylate homopolymer and a modified product thereof, an ethylene glycol di(meth)acrylate/glycerin di(meth)acrylate copolymer and a modified product thereof, a trimethylol propane tri(meth)acrylate/alkyl (meta)acrylate copolymer, a trimethylol propane tri(meth)acrylate homopolymer, a pentaerythritol tri(meth)acrylate/alkyl (meth)acrylate copolymer and a modified product thereof, a pentaerythritol tri(meth)acrylate homopolymer and a modified product thereof, a vinyl (meth)acrylate homopolymer and a hydrolyzed or modified product of an oxirane ring of an ethylene glycol di(meth)acrylate/glycidyl (meth)acrylate copolymer.

Examples of the polymer particle where the ester bond as a problem is contained in a part of the structure include those containing one or a plurality of partial structures selected from an amide, an imide, an alcohol, an ether, an aromatic ring, an alkyl chain and the like at the same time in addition to the above-described ester structures.

Such a polymer particle contains an ester bond and when the polymer particle is used in an acid or alkali hydrous solution, the ester bond exposed to the particle surface is hydrolyzed. Therefore, this polymer particle is low in the acid.alkali durability.

The modified polymer particle as referred to in the present invention includes all of the polymer particles containing an ester bond exemplified above, where the ester bond which is exposed to the surface and becomes readily hydrolyzable is previously cut by an acid or alkali hydrous solution and the produced free carboxyl group is capped through amidation.

The amide bond is less hydrolyzable than the ester bond (see, PROTECTIVE GROUPS in ORGANIC SYNTHESIS, 3rd ed., page 442, middle column) and therefore, when an ester bond readily coming into contact with liquid is previously cut and the produced free carboxyl group is capped through amidation and converted into an amide bond, the production of a carboxyl group can be prevented even if the polymer particle is used in an acid or alkali solution, and the durability of the polymer particle is enhanced.

That is, the ester bond readily coming into contact with liquid as referred to in the present invention is an ester bond present relatively near the polymer surface. By converting such an ester bond into an amide bond, the polymer surface is protected by a less hydrolyzable amide bond as described above, as a result, the ester bond not hydrolyzed by an acid or alkali treatment becomes more difficult of coming into contact with liquid on use as a column or the like and thereby, the polymer particle is considered to increase in the acid.alkali durability.

In the present invention, the polymer particle as an objective of the modification may have various sizes according to use. In the case of use as a packing material for chromatography, the polymer particle preferably has an average particle size of 1 to 50 μm, more preferably from 1.5 to 30 μm, still more preferably from 2 to 10 μm. If the average particle size is less than 1 μm, the column pressure excessively increases to surpass the strength limit of the particle and this is not preferred, whereas if the average particle size exceeds 50 μm, the separation ability is low and this is not preferred in practice.

The method for the treatment with an acid or alkali hydrous solution performed in the present invention so as to cut the readily hydrolyzable ester bond which is considered to be exposed to the polymer particle surface is specifically described below.

As the acid hydrous solution, an aqueous solution of hydrochloric acid, sulfuric acid or the like can be used. In the case where the polymer particle is less wettable to such an aqueous solution, a water-soluble organic solvent of not undergoing a reaction in a strongly acidic solution, such as dimethylsulfoxide, may be added in an appropriate amount before use of the aqueous solution. The concentration is not particularly limited as long as the ester bond on the polymer particle surface can be hydrolyzed, but the polymer particle is suspended by appropriately controlling the concentration such that the solution has a pH of 3 or less, preferably from 1 to 2. The reaction temperature is not particularly limited as long as the ester bond on the polymer particle surface can be hydrolyzed, but the reaction temperature is suitably set to 20 to 100° C., preferably from 30 to 80° C., more preferably from 40 to 60° C. The reaction term is also not particularly limited as long as the ester bond on the polymer particle surface can be hydrolyzed, but the reaction is suitably performed with stirring for 30 minutes to 24 hours, preferably from 30 minutes to 10 hours, more preferably from 1 to 6 hours.

As the alkali hydrous solution, an aqueous solution of a hydroxide such as sodium hydroxide and potassium hydroxide can be used. In the case where the polymer particle is less wettable to such an aqueous solution, a water-soluble organic solvent of not undergoing a reaction in a strongly alkaline solution, such as dimethylsulfoxide, may be added in an appropriate amount before use of the aqueous solution. The concentration is not particularly limited as long as the ester bond on the polymer particle surface can be hydrolyzed, but the polymer particle is suspended by appropriately controlling the concentration such that the solution has a pH of 10 to 14, preferably from 11 to 13. The reaction temperature is not particularly limited as long as the ester bond on the polymer particle surface can be hydrolyzed, but the reaction temperature is suitably set to 20 to 100° C., preferably from 30 to 80° C., more preferably from 40 to 60° C. The reaction term is also not particularly limited as long as the ester bond on the polymer particle surface can be hydrolyzed, but the reaction is suitably performed with stirring for 20 minutes to 24 hours, preferably from 30 minutes to 10 hours, more preferably from 1 to 6 hours.

These ranges of pH, reaction temperature and reaction term in the conditions of hydrolysis of the ester bond may be individually adjusted and used, but all conditions are preferably adjusted in combination.

The method for the amidation used to achieve capping in the present invention is specifically described below.

The amine used for the amidation is basically not limited as long as the free carboxyl group can be capped, but on considering the reactivity at the amidation, the limitation of introduction due to steric hindrance, and the stability after the conversion into an amide, the amine used therefor is preferably an amine represented by formula (1):
NHR¹R² (1)
(wherein R¹ and R² each independently represents a hydrogen atom, an alkyl group having a carbon number of 18 or less, which may be branched or may be substituted by a halogen, or a phenyl group).

The amine is more preferably a primary amine represented by formula (2):
NH₂R³ (2)
(wherein R³ represents a hydrogen atom, an alkyl group having a carbon number of 18 or less, which may be branched or may be substituted by a halogen, or a phenyl group).

A smaller substituent size is advantageous in that the introduction efficiency increases due to small steric hindrance and the hydrophobicity of the polymer particle before modification is not largely changed. However, in the case where the amount of the free carboxyl group to be capped is very small, the hydrophobicity is less changed even when a relatively large inactive group is introduced, therefore, a substituent having a large size to a certain extent can be used. More specifically, in the case of an alkylamine, the alkyl group preferably has a carbon number of 18 or less, more preferably 12 or less, still more preferably 6 or less, and particularly preferably 4 or less.

Examples thereof include ammonia, methylamine, ethylamine, 1-propylamine, isopropylamine, 1-butylamine, isobutylamine, tert-butylamine, 1-hexylamine, cyclohexyl-amine, 1-octylamine, dimetylamine, dietylamine and di(1-propyl) amine.

For the amidation in the present invention, a method commonly used in the peptide synthesis or the like can be employed. However, it is necessary that the portion except for the free carboxyl group of a polymer particle to be modified is not adversely affected. Furthermore, from the practical aspects such as introduction efficiency, ease of handling and cost, the amidation is preferably performed by using the following combination of reagents.

(A) (i) A reagent for the production of a mixed acid anhydride, such as ethyl chloroformate; a tertiary amine such as triethylamine; and an organic solvent such as chloroform, and then (ii) an amine represented by formula (1).

(B) An amine represented by formula (2) such as 1-propylamine; a dehydration condensing agent such as N,N′-diisopropylcarbodiimide; and an organic solvent such as toluene and N,N-dimethylformamide.

The modification method of a polymer particle containing an ester bond of the present invention is characterized in that a polymer particle is treated with the above-described acid or alkali hydrous solution and further brought into contact with a solution or suspension containing those amidation reagents.

That is, a readily hydrolyzable ester bond which is considered to be exposed to the polymer particle surface is first hydrolyzed by treating the polymer particle with an acid or alkali hydrous solution and then the isolated carboxyl group is converted into an amide group by contacting the polymer particle with a solution or suspension containing amidation reagents.

The polymer particle subjected to modification may be or may not be previously packed in a column. More specifically, one or both of the hydrolysis treatment by the acid or alkali hydrous solution and the capping treatment through amidation may be performed in the state of the polymer particle being packed in a column. For treating the polymer particle in the packed state, a method of feeding a solution or suspension containing the reagents to the column is used. The pattern regarding the feeding amount, temperature, rate and time, the standing conditions after feeding, and the like are appropriately selected as needed to complete the reaction.

With a conventional liquid chromatography column packed with a polymer particle containing an ester bond readily coming into contact with liquid, the elution time and peak shape of an organic base such as pyridine sometimes greatly change between before and after the passing of a strongly acidic or strongly alkaline eluent. On the other hand, with a liquid chromatography column packed with the polymer particle of the present invention, the elution time and peak shape of an organic base such as pyridine are remarkably suppressed from changing between before and after the passing of a strongly acidic or strongly alkaline eluent.

The problems encountered in the measurement using a conventional liquid chromatography column packed with a polymer particle containing an ester bond readily coming into contact with liquid is considered ascribable to the production of a free carboxyl group resulting from the hydrolysis of an ester bond exposed to the polymer particle surface at the passing of a strongly acidic or strongly alkaline eluent. As the free carboxyl group, a proton-type (R—COOH) carboxyl group and a metal-type (R—COOM) carboxyl group are considered to exist together. An organic base such as pyridine (the organic base is hereinafter referred to as “pyridine”) is greatly adsorbed mainly to the former. This is because the pH is locally low in the vicinity of the proton-type carboxylic acid (R—COOH) and the equilibrium of pyridine and pyridinium ion inclines to the pyridinium ion, as a result, an ionic bond of R—COO(−)→HNC₅H₅(+) is readily generated. If an eluent completely free of a salt is used, this phenomenon more noticeably appears, because if a slight amount of metal is mixed in an eluent, the metal is captured on passing near the proton-type carboxylic acid (R—COOH) and concentrated in the column, as a result, a metal-type carboxylic acid (R—COOM) increases and pyridine is less adsorbed. In order to accurately evaluate the alkali durability, the metal-type carboxylic acid (R—COOM) need be converted into a proton-type carboxylic acid (R—COOH). For this purpose, an acid solution containing phosphoric acid may be passed through the column before analyzing pyridine.

From these points, when the pyridine analysis is performed before and after passing a strongly acidic or strongly alkaline eluent through the objective column to be evaluated, the effect of modification can be clearly detected.

More specifically, when an ester bond is hydrolyzed and a free carboxyl group is produced, the retention volume of pyridine increases and the peak shape tails, therefore, the effect of the present invention can be detected by comparing the polymer particle after modification according to the present invention with the polymer particle before modification.

By this method, the effect on the acid.alkali durability of a polymer particle, which is attained by the modification comprising a hydrolysis treatment with an acid or alkali hydrous solution and a capping treatment through amidation, can be verified.

### EXAMPLES

The present invention is described in greater detail below by referring to Examples, however, the present invention is not limited to these Examples. In Example 1, the production process of a polymer-base packing material suitable for reverse phase liquid chromatography column is described all the way from the initial preparation of base material gel to the final introduction of carbon chain, but steps 3 and 4 are the portions substantially concerned in the present invention. As such, the method of the present invention can be utilized by inserting it on the way in a series of steps for producing a polymer particle.

### Example 1

<Step 1: Synthesis of Base Material Crosslinked Polymer Particle>

In a mixed solution containing 2,000 g of glycerin dimethacrylate and 900 g of 1-hexanol, 30 g of 2,2′-azobis(isobutyronitrile) was dissolved to prepare an oil phase. Separately, 180 g of polyvinyl alcohol (KURARAY POVAL PVA-224, produced by Kuraray Co., Ltd.) was dissolved in 3 liter of water and thereto, 7 liter of water and subsequently a solution obtained by dissolving 240 g of sodium chloride in 2 liter of water and a solution obtained by dissolving 15 g of sodium dodecylsulfate in 485 ml of water were added and mixed to prepare an aqueous phase. The obtained oil phase and aqueous phase were mixed in a 20 L-volume stainless steel-made container and dispersed in a high-speed disperser (homogenizer) by adjusting the rotation number and dispersion time such that the maximum particle size of oil droplet became 3 μm.

The obtained dispersion was reacted at 70° C. for 4 hours while stirring at 150 rpm. The crosslinked polymer particle produced was centrifuged (at 2,000 rpm for 10 minutes) and after discarding the supernatant, the precipitate was dispersed (by using an ultrasonic washer) in 12 liter of warm water at 70° C. and then stirred at 70° C. for 3 hours. The resulting solution was filtered by suction and the gel on the funnel was washed with 60 liter of warm water at 70° C. and then with 18 liter of acetone, air-dried by spreading it in a stainless steel-made vat, and further dried under reduced pressure at 60° C. for 24 hours. The polymer particles obtained were classified by a pneumatic classifier to obtain 716 g of crosslinked polymer particles having a weight average particle size of 3 μm (hereinafter, this polymer particle is referred to as a “base material gel”).

<Step 2: Thorough Washing>

Pure water (500 ml) was added to 50 g of the base material gel obtained in the step 1 and stirred under heating at 60° C. for 5 hours. Thereafter, the particles were collected by filtration, washed in sequence with 2,000 ml of warm water at 70° C. and then with 300 ml of methanol, then air-dried by spreading the particles in a stainless steel-made vat, and further dried under reduced pressure at 60° C. for 24 hours to obtain 49 g of a thoroughly washed base material gel.

<Step 3: Hydrolysis Treatment with Alkali Hydrous Solution>

The thoroughly washed base material gel (10 g) obtained in the step 2 was dispersed in 50 ml of an aqueous 0.1N sodium hydroxide solution and stirred at 50° C. for 2 hours. The reaction liquid was filtrated by suction and the gel on the funnel was washed in sequence with 100 ml of 0.01N hydrochloric acid solution, with 500 ml of water and with 100 ml of acetone, then air-dried by spreading the gel in a stainless steel-made vat and further dried under reduced pressure at 60° C. for 3 hours to obtain 10 g of a hydrolyzed gel.

<Step 4: Capping through Amidation>

The hydrolyzed gel (10 g) obtained in the step 3 was dispersed in 50 ml of chloroform at 25° C. While stirring the dispersion in a water bath at 25° C., 2.3 g of triethylamine was added, after 5 minutes, 2.5 g of ethyl chloroformate was added, and after 30 minutes therefrom, 1.6 g of 1-propylamine was added. Then, these were reacted for 3 hours. The reaction mixture was filtrated by suction and the gel on the funnel was washed in sequence with 100 ml of chloroform, with 500 ml of water and with 100 ml of acetone, then air-dried by spreading the gel in a stainless steel-made vat, and further dried under reduced pressure at 60° C. for 3 hours to obtain 10 g of an amidated and capped gel.

<Step 5: Surface Crosslinking and Epoxy Ring-Opening Reaction>

The amidated and capped gel (10 g) obtained in the step 4 and 1 g of ethylene glycol diglycidyl ether were added to 50 ml of toluene and while stirring these in a water bath at 40° C., 0.5 g of boron trifluoride diethyl ether complex was added and reacted for 3 hours. The reaction mixture was filtrated by suction and the gel on the funnel was washed with 100 ml of acetone and then with 500 ml of water. The gel was transferred to a reaction vessel and thereto, 50 ml of 0.1N hydrochloric acid was added and reacted at 50° C. for 1 hour. The reaction mixture was filtered by suction and the gel on the funnel was washed with 500 ml of water and then with 100 ml of acetone, thereafter air-dried by spreading the gel in a stainless steel-made vat, and further dried under reduced pressure at 60° C. for 3 hours to obtain 11.5 g of a surface crosslinked gel.

<Step 6: Reaction for C18 Formation>

The surface crosslinked gel (10 g) obtained in the step 5 and 3 g of octadecyl glycidyl ether were dispersed in 100 ml of toluene and while stirring in a water bath at 40° C., 0.5 g of boron trifluoride diethyl ether complex was added and reacted for 3 hours. The reaction mixture was filtrated by suction and the gel on the funnel was washed in sequence with 100 ml of toluene, with 300 ml of tetra-hydrofuran, with 500 ml of water and with 100 ml of acetone, then air-dried by spreading the gel in a stainless steel-made vat, and further dried under reduced pressure at 60° C. for 3 hours to obtain 10.5 g of a carbon chain-introduced gel.

<Packing of Modified Gel>

The carbon chain-introduced gel obtained in the step 6 was packed in a stainless steel-made column of 4.6 mm (inner diameter)×150 mm (length) by a slurry method to produce a reverse phase chromatography column (hereinafter called “Column A”).

### Comparative Example 1

A column was produced by excluding the steps 3 and 4 in the column production process of Example 1 (hereinafter called “Column B”).

### Comparative Example 2

A column was produced by excluding the step 4 in the column production process of Example 1 (hereinafter called “Column C”).

(1. Comparison of Alkali Durability)

Example 1 (Column A) and Comparative Example 1 (Column B) each was evaluated on the alkali durability by the following method. For clearly showing the effect by the capping through amidation, the pyridine/phenol test results of Comparative Example 2 (Column C) are also shown.

1-1. Alkali Durability Evaluation Method

1-1-1. Pyridine/Phenol Test in Initial State

An acidic eluent was passed through the test objective column under the following conditions. This was performed so as to partialize a free carboxyl group, if present, to a proton type (RCOOH).
Eluent: CH₃CN/aqueous 0.1% phosphoric acid solution=30/70 (v/v)
Flow rate: 0.3 ml/min
Column temperature: 25° C.
Eluent passing time: 30 minutes

Subsequently, the conditions were changed to the following conditions and after the liquid displacement for 30 minutes or more, pyridine and phenol were analyzed.
Eluent: CH₃CN/H₂O=30/70 (v/v)
Flow rate: 1.00 ml/min
Column temperature: 40° C.
   1-1-2. Passing of Strongly Alkaline Eluent

Through the test objective column after the completion of a pyridine/phenol test in the initial state, a strongly alkaline eluent was passed under the following conditions. By this operation, an ester bond readily coming into contact with liquid was, if present, hydrolyzed to produce a free carboxyl group.
Eluent: CH₃CN/0.01N—NaOH (pH: 12)=50/50 (v/v)
Flow rate: 0.50 ml/min
Column temperature: 40° C.
Eluent passing time: 4 hours
   1-1-3. Pyridine/Phenol Test after Passing of Strongly Alkaline Eluent

Using the test objective column after the passing of a strongly alkaline eluent, a pyridine/phenol test was performed by the same procedure as in above 1-1-1.

1-2. Alkali Durability Evaluation Results

The evaluation results of Column A and Column B are shown in Table 1. In the Table, the retentivity k′ was calculated from a non-retention time t₀ and a compound retention time tᵣ according to the following formula:
k′=(tᵣ-t₀)/t₀

The tailing coefficient T was calculated from a peak width W_{0.05h} at a peak height of 5% and a peak width f in the peak rising side according to the following formula:
T=W_{0.05h}/f

TABLE 1

| | Pyridine | | Phenol | | Pyridine Tailing | |
|---|---|---|---|---|---|---|
| | Retentivity k′ | | Retentivity k′ | | Coefficient | |
| | | After | | After | | After |
| | | Passing of | | Passing of | | Passing of |
| | | Strongly | | Strongly | | Strongly |
| | Initial | Alkaline | Initial | Alkaline | Initial | Alkaline |
| | State | Eluent | State | Eluent | State | Eluent |
| Column A | 1.5 | 1.6 | 3.6 | 3.6 | 0.75 | 0.75 |
| Column B | 1.6 | 2.5 | 3.6 | 3.6 | 1.5 | 4.3 |
| Column C | 4.7 | — | 3.6 | — | 5.8 | — |

In both of Column A and Column B, the phenol retentivity k′ was not changed between the initial state and after passing of strongly alkaline eluent, but in Column B, the pyridine retentivity was increased by 56% and the tailing coefficient was also increased. This seems to reveal that an ester bond was hydrolyzed during the passing of a strongly alkaline eluent and a free carboxyl group was produced. On the contrary, in Column A, the pyridine peak was scarcely changed and this seems to reveal that the effect of the present invention was noticeably brought out.

Furthermore, by comparing the pyridine retentivity and the tailing coefficient in the initial state of Column A with those of Column C, it can be confirmed that the carboxyl group produced by the alkali treatment in the production process of a packing material was amidated and thereby capped.

(2. Comparison of Acid Durability)

Example 1 (Column A) and Comparative Example 1 (Column B) were evaluated on the acid durability by the following method.

2-1. Acid Durability Evaluation Method

2-1-1. Pyridine/Phenol Test in Initial State

The pyridine/phenol test was performed by the same procedure as in above 1-1-1.

2-1-2. Passing of Strongly Acidic Eluent

Through the test objective column after the completion of a pyridine/phenol test in the initial state, a strongly acidic eluent was passed under the following conditions. By this operation, an ester bond readily coming into contact with liquid was, if present, hydrolyzed to produce a free carboxyl group.
Eluent: MeOH/aqueous 1% trifluoroacetic acid solution (pH: 1.2)=10/90 (v/v)
Flow rate: 1.00 ml/min
Column temperature: 40° C.
Eluent passing time: 70 hours
   2-1-3. Pyridine/Phenol Test after Passing of Strongly Acidic Eluent

Using the test objective column after the passing of a strongly acidic eluent, a pyridine/phenol test was performed by the same procedure as in above 1-1-1.

2-2. Acid Durability Evaluation Results

The evaluation results of Column A and Column B are shown in Table 2. In the Table, the retentivity k′ was calculated from a non-retention time t₀ and a compound retention time tᵣ according to the following formula:
k′=(tᵣ-t₀)/t₀

The tailing coefficient T was calculated from a peak width W_{0.05h} at a peak height of 5% and a peak width f in the peak rising side according to the following formula:
T=W_{0.05h}/f

TABLE 2

| | Pyridine | | Phenol | | Pyridine Tailing | |
|---|---|---|---|---|---|---|
| | Retentivity k′ | | Retentivity k′ | | Coefficient | |
| | | After | | After | | After |
| | | Passing of | | Passing of | | Passing of |
| | | Strongly | | Strongly | | Strongly |
| | Initial | Acidic | Initial | Acidic | Initial | Acidic |
| | State | Eluent | State | Eluent | State | Eluent |
| Column A | 1.4 | 1.6 | 3.6 | 3.6 | 0.75 | 0.75 |
| Column B | 1.6 | 2.6 | 3.6 | 3.6 | 1.5 | 3.6 |

In both of Column A and Column B, the phenol retentivity was not changed between-the initial state and after passing of strongly acidic eluent, but in Column B, the pyridine retentivity was increased by 63% and the tailing coefficient was also increased. This seems to reveal that an ester bond was hydrolyzed during the passing of a strongly acidic eluent and a free carboxyl group was produced. On the contrary, in Column A, the pyridine peak was scarcely changed and this seems to reveal that the effect of the present invention was noticeably brought out.

The polymer particle modified by the method of the present invention was packed to produce a column for chromatography and organic bases such as pyridine were analyzed before and after the passing of a strongly acidic or strongly alkaline eluent and compared, as a result, the increase in retentivity and the tailing of peak were noticeably suppressed and the effect of the present invention could be confirmed.

### INDUSTRIAL APPLICABILITY

In the modified polymer particle of the present invention, an ester bond present near the surface and readily coming into contact with liquid is hydrolyzed and a carboxyl group produced is converted into an amide group, therefore, after the treatment, a less hydrolyzable amide bond is present on the surface and the remaining ester bond becomes difficult to contact with liquid, as a result, the acid.alkali durability is considered to increase.

The polymer particle of the present invention can be used as a packing material for chromatography and a column packed with this polymer particle exhibits high acid.alkali durability and therefore, is useful over a wide range of fields, such as separation and analysis of medical or agrochemical preparations, food additives, intermediates thereof, natural or synthetic polymers, additives thereof, and environmental pollutants.

1. A modified polymer particle improved in the acid.alkali durability, obtained by treating a polymer particle containing an ester bond with an acid or alkali hydrous solution to partially hydrolyze the ester bond and isolate a carboxyl group and capping the free carboxyl group through amidation.

2. The modified polymer particle improved in the acid.alkali durability as claimed in claim 1, wherein the ester bond having been hydrolyzed is an ester bond readily coming into contact with liquid.

3. The modified polymer particle improved in the acid.alkali durability as claimed in claim 1, wherein the amine used for the amidation is an amine represented by formula (1):
NHR¹R² (1)
(wherein R¹ and R² each independently represents a hydrogen atom, an alkyl group having a carbon number of 18 or less, which may be branched or may be substituted by a halogen, or a phenyl group).

4. The modified polymer particle improved in the acid.alkali durability as claimed in claim 3, wherein the amine used for the amidation is an amine represented by formula (2):
NH₂R³ (2)
(wherein R³ represents a hydrogen atom, an alkyl group having a carbon number of 18 or less, which may be branched or may be substituted by a halogen, or a phenyl group).

5. A modified polymer particle improved in the acid.alkali durability, wherein when the polymer particle is packed in a column having an inner diameter of 4.6 mm and a length of 150 mm and the alkali durability is evaluated using the column by the following method, the increase percentage of the pyridine retentivity after passing an alkali eluent is 50% or less:
Evaluation Method:
(1) an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min,
(2) an alkali eluent of acetonitrile/aqueous 0.01 mol sodium hydroxide solution=50/50 is passed through the same column at a flow rate of 0.5 ml/min for 4 hours at a column temperature of 40° C., then an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min, and
(3) the pyridine retentivity of (2) is compared with the pyridine retentivity of (1).

6. The modified polymer particle improved in the acid-alkali durability as claimed in any one of claims 1 to 5, wherein the average particle size of the polymer particle is from 1 to 50 μm.

7. A polymer-base packing material for chromatography, using a modified polymer particle improved in the acid.alkali durability, the polymer particle being obtained by treating a polymer particle containing an ester bond with an acid or alkali hydrous solution to partially hydrolyze the ester bond and isolate a carboxyl group and then capping the free carboxyl group through amidation.

8. The polymer-base packing material for chromatography as claimed in claim 7, wherein the ester bond having been hydrolyzed is an ester bond readily coming into contact with liquid.

9. The polymer-base packing material for chromatography as claimed in claim 7, wherein the amine used for the amidation is an amine represented by formula (1):
NHR¹R² (1)
(wherein R¹ and R each independently represents a hydrogen atom, an alkyl group having a carbon number of 18 or less, which may be branched or may be substituted by a halogen, or a phenyl group).

10. The polymer-base packing material for chromatography as claimed in claim 9, wherein the amine used for the amidation is an amine represented by formula (2):
NH₂R³ (2)
(wherein R³ represents a hydrogen atom, an alkyl group having a carbon number of 18 or less, which may be branched or may be substituted by a halogen, or a phenyl group).

11. A polymer-base packing material for chromatography, using a modified polymer particle improved in the acid-alkali durability such that when the polymer particle is packed in a column having an inner diameter of 4.6 mm and a length of 150 mm and the alkali durability is evaluated using the column by the following method, the increase percentage of the pyridine retentivity after passing an alkali eluent is 50% or less:
Evaluation Method:
(1) an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min,
(2) an alkali eluent of acetonitrile/aqueous 0.01 mol sodium hydroxide solution=50/50 is passed through the same column at a flow rate of 0.5 ml/min for 4 hours at a column temperature of 40° C., then an eluent of acetonitrile/aqueous 0.1 % phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min, and
(3) the pyridine retentivity of (2) is compared with the pyridine retentivity of (1).

12. The polymer-base packing material for chromatography as claimed in any one of claims 7 to 11, wherein the average particle size of the polymer particle is from 1 to 50 μm.

13. A method for producing a modified polymer particle improved in the acid.alkali durability, comprising treating a polymer particle containing an ester bond with an acid or alkali hydrous solution to partially hydrolyze the ester bond and isolate a carboxyl group and then capping the free carboxyl group through amidation.

14. The method for producing a modified polymer particle improved in the acid.alkali durability as claimed in claim 13, wherein the ester bond having been hydrolyzed is an ester bond readily coming into contact with liquid.

15. The method for producing a modified polymer particle improved in the acid-alkali durability as claimed in claim 13, wherein the amine used for the amidation is an amine represented by formula (1):
NHR¹R² (1)
(wherein R¹ and R² each independently represents a hydrogen atom, an alkyl group having a carbon number of 18 or less, which may be branched or may be substituted by a halogen, or a phenyl group).

16. The method for producing a modified polymer particle improved in the acid.alkali durability as claimed in claim 15, wherein the amine used for the amidation is an amine represented by formula (2):
NH₂R³ (2)
(wherein R³ represents a hydrogen atom, an alkyl group having a carbon number of 18 or less, which may be branched or may be substituted by a halogen, or a phenyl group).

17. The method for producing a modified polymer particle improved in the acid-alkali durability as claimed in any one of claims 13 to 16, wherein when the polymer particle is packed in a column having an inner diameter of 4.6 mm and a length of 150 mm and the alkali durability is evaluated using the column by the following method, the increase percentage of the pyridine retentivity after passing an alkali eluent is 50% or less:
Evaluation Method:
(1) an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min,
(2) an alkali eluent of acetonitrile/aqueous 0.01 mol sodium hydroxide solution=50/50 is passed through the same column at a flow rate of 0.5 ml/min for 4 hours at a column temperature of 40° C., then an eluent of acetonitrile/aqueous 0.1% phosphoric acid solution=30/70 is passed at a flow rate of 0.3 ml/min for 30 minutes, the column temperature is set to 40° C., and the pyridine retentivity is measured by using an eluent of acetonitrile/water=30/70 at a flow rate of 0.5 ml/min, and
(3) the pyridine retentivity of (2) is compared with the pyridine retentivity of (1).

18. The method for producing a modified polymer particle improved in the acid-alkali durability as claimed in any one of claims 13 to 16, wherein the average particle size of the polymer particle is from 1 to 50 μm.

19. A method for producing a polymer-base packing material for chromatography, comprising producing the polymer-base packing material for chromatography described in claim 6 by performing one or both of the hydrolysis treatment with an acid or alkali hydrous solution and the capping treatment through amidation, in the state of the polymer-base packing material being packed in the column.

20. A chromatography column using the polymer-base packing material for chromatography improved in the acid-alkali durability described in claim 6.
